(19) United States
(12) Patent Application Publication
(10) Pub. No.: US 2024/0107540 A1
(43) Pub. Date: Mar. 28, 2024

(54) METHOD FOR SENDING UPLINK CONTROL INFORMATION, DEVICE AND STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/275,788

(22) PCT Filed: Feb. 5, 2021
(86) PCT No.: PCT/CN2021/075494

§ 371 Date: Aug. 3, 2023

(51) Int. Cl. H04W 72/21; H04L 1/1812; H04W 72/12; H04W 72/566

(52) U.S. Cl. CPC H04W 72/21; H04L 1/1812; H04W 72/12; H04W 72/566

(57) ABSTRACT

A method for sending uplink control information, the method includes: sending, in response to physical uplink control channels (PUCCHs) of at least two pieces of uplink control information (UCIs) overlapping in a time domain and the at least two UCIs including at least one UCI corresponding to a PUCCH format0 (PF0) format and having a high priority, multiplexed UCI over a PUCCH of the PF0 format corresponding to any UCI in the at least one UCI corresponding to the PF0 format and having the high priority. The multiplexed UCI includes a cyclic shift state corresponding to a combination of the at least two UCIs.

### CROSS REFERENCE TO RELATED APPLICATION

The present application is a U.S. National Stage of International Application No. PCT/CN2021/075494, filed on Feb. 5, 2021, the contents of all of which are incorporated herein by reference in their entireties for all purposes.

### BACKGROUND

A fifth generation (5G) new radio (NR) system is compatible with multiple types of services, such as an ultra-reliable low latency communication (URLLC) service and an enhanced mobile broadband (eMBB) service.

The URLLC service is widely applied in 5G scenarios such as factory automation, remote control, and AR/VR, typically demanding very high reliability and very low latency.

The eMBB service is aimed at a high-traffic mobile broadband service. Based on an existing mobile broadband service scenario, it further improves user experience and other performance by demanding very high rate but not very low latency and very low error rate.

### SUMMARY

According to a first aspect, an example of the disclosure provides a method for sending uplink control information, performed by a user device, the method including: sending, in response to physical uplink control channels (PUCCHs) of at least two pieces of uplink control information (UCIs) overlapping in a time domain and the at least two UCIs including at least one UCI corresponding to a PUCCH format0 (PF0) format and having a high priority, multiplexed UCI over a PUCCH of the PF0 format corresponding to any UCI in the at least one UCI corresponding to the PF0 format and having the high priority, where the multiplexed UCI includes a cyclic shift state corresponding to a combination of the at least two UCIs.

According to a second aspect, an example of the disclosure provides a method for sending uplink control information, performed by a user device, the method including: in response to physical uplink control channels (PUCCHs) of at least three pieces of uplink control information (UCIs) overlapping in a time domain, and the at least three UCIs at least including: hybrid automatic repeat request ACK (HARQ-ACK) corresponding to a PUCCH format1 (PF1) format and having a high priority, a scheduling request (SR) corresponding to the PF1 format and having a high priority, and UCI corresponding to a PUCCH format0 (PF0) format or the PF1 format and having a low priority, when determining that a value of the SR is a positive value, sending multiplexed UCI over a PUCCH of the SR corresponding to the PF1 format and having the high priority, where the multiplexed UCI is a combination of the HARQ-ACK corresponding to the PF1 format and having the high priority and the UCI corresponding to the PF0 format or the PF1 format and having the low priority; and when determining that the value of the SR is a negative value, sending the multiplexed UCI over a PUCCH of the HARQ-ACK corresponding to the PF1 format and having the high priority, where the multiplexed UCI is a combination of the HARQ-ACK corresponding to the PF1 format and having the high priority and an HARQ-ACK corresponding to the PF0 format or the PF1 format and having a low priority.

According to a third aspect, an example of the disclosure provides a user device, including: a processor; and a memory, used for storing executable instructions of the processor, where the processor is configured to execute the executable instructions in the memory so as to implement steps of the method for sending the uplink control information.

According to a fourth aspect, an example of the disclosure provides a non-transitory computer-readable storage medium, storing executable instructions, the executable instructions, when executed by a processor, implementing steps of the method for sending the uplink control information.

It is to be understood that the above general description and the following detailed description are merely for example and explanatory, and cannot limit the disclosure.

### BRIEF DESCRIPTION OF THE DRAWINGS

Accompanying drawings illustrated here are used for providing a further understanding of the examples of the disclosure, and constitute a part of the present application. The schematic examples and their explanations of the examples of the disclosure are used for explaining the examples of the disclosure and do not constitute an improper limitation on the examples of the disclosure.

The accompanying drawings here, which are incorporated in and constitute a part of this specification, illustrate examples consistent with the examples of the disclosure and together with the specification, serve to explain the principles of the examples of the disclosure.

FIG. 1 is a flow diagram of a method for sending uplink control information shown according to an example.

FIG. 2 is a flow diagram of a method for sending uplink control information shown according to an example.

FIG. 3 is a structural diagram of an apparatus for sending uplink control information shown according to an example.

FIG. 4 is a structural diagram of an apparatus for sending uplink control information shown according to an example.

FIG. 5 is a structural diagram of an apparatus for sending uplink control information shown according to an example.

### DETAILED DESCRIPTION

Examples of the disclosure are further illustrated with reference to accompanying drawings and specific implementations.

Examples will be illustrated in detail here, and instances of which are represented in the accompanying drawings. When the following description refers to the accompanying drawings, the same number in the different accompanying drawings represents the same or similar elements unless otherwise indicated. The implementations described in the following examples do not represent all implementations consistent with the examples of the disclosure. On the contrary, they are merely examples of an apparatus and method consistent with some aspects of the disclosure as detailed in the appended claims.

The disclosure relates to the technical field of wireless communications, in particular to a method for sending uplink control information, a device and a storage medium.

In order to correspond to demands of different services for different reliability and different latencies, different priorities of hybrid automatic repeat request ACK (HARQ-ACK) information of the service and different priorities of a scheduling request (SR) may be determined at a physical layer.

For an HARQ-ACK there may be a dynamic scheduling physical downlink shared channel (PDSCH) and/or a semi-persistent scheduling physical downlink shared channel (SPS PDSCH).

For a dynamic scheduling physical downlink shared channel (PDSCH), priority indication may be used during scheduling of downlink control information (DCI) of the PDSCH to indicate a priority of the HARQ-ACK corresponding to the scheduled PDSCH.

For a semi-persistent scheduling physical downlink shared channel (SPS PDSCH), a priority of the HARQ-ACK corresponding to the scheduled SPS PDSCH may be configured in radio resource control (RRC) configuration information.

For an SR: a priority of the SR may be configured through an RRC layer signaling.

The priority of the HARQ-ACK and the priority of the SR may include: a high priority and a low priority. Alternatively, it may further include two or more priorities.

Uplink control information (UCI) includes three types: the HARQ-ACK, the SR, and channel state information (CSI). The CSI is considered as the low priority in a current protocol. Usually, the number of bits in HARQ-ACK information may be one or more, the number of bits in the SR information may be one or more, and the number of bits in the CSI may be greater than 2.

The UCI information is carried on a PUCCH channel. A PUCCH format (PF) includes various formats, such as a PF0 format and a PF1 format. The PF0 format includes a sequence with a frequency domain length of 12 resource elements (REs), and UCI of 1 to 3 bits may be represented by using different cyclic shifts of the sequence. The PF1 format may carry UCI of 2 bits or less.

If the plurality of PUCCHs overlap in the time domain, there is a demand to multiplex the UCIs on the plurality of PUCCH channels onto one PUCCH (i.e., using one PUCCH to carry the plurality of UCIs), and a priority of the UCIs in a multiplexing process needs to be considered under this demand.

Overlapping of the plurality of PUCCHs in the time domain includes: different PUCCHs in the plurality of PUCCHs have the identical time domain resources. Alternatively, overlapping of the plurality of PUCCHs in the time domain includes: the time domain resources of the plurality of PUCCHs have an intersection, that is, the time domain resource corresponding to each PUCCH includes a part of same time domain resources.

In view of this, examples of the disclosure provide a method for sending uplink control information, a device and a storage medium.

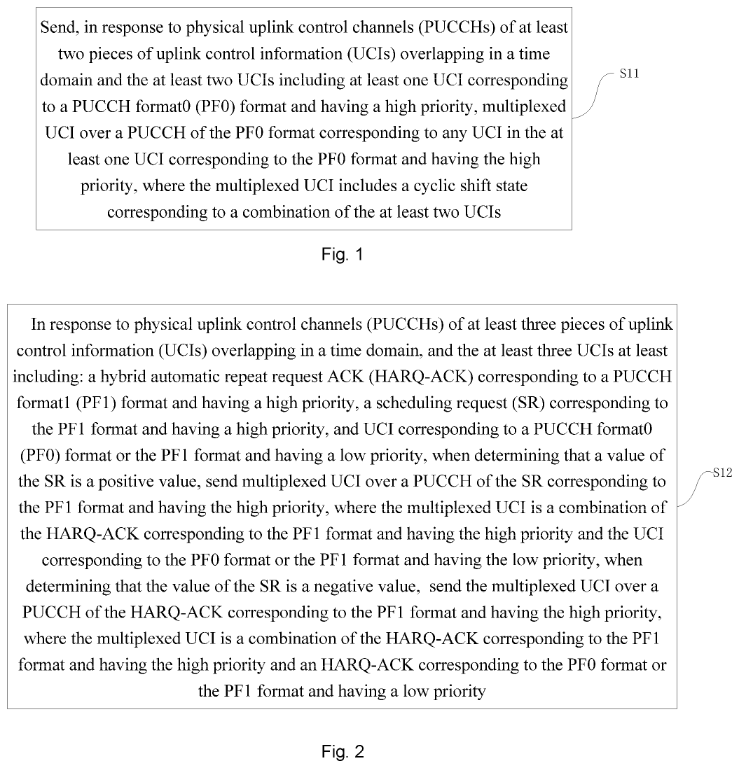

An example of the disclosure provides a method for sending uplink control information, performed by a user device. Referring to FIG. 1, FIG. 1 is a flow diagram of a method for sending uplink control information shown according to an example. As shown in FIG. 1, the method includes step S11.

In step S11, in response to physical uplink control channels (PUCCHs) of at least two pieces of uplink control information (UCIs) overlapping in a time domain and the at least two UCIs including at least one UCI corresponding to a PUCCH format0 (PF0) format and having a high priority, a multiplexed UCI is sent over a PUCCH of the PF0 format corresponding to any UCI in the at least one UCI corresponding to the PF0 format and having the high priority. Where the multiplexed UCI includes a cyclic shift state corresponding to a combination of the at least two UCIs.

In an implementation, overlapping of the PUCCHs of the at least two UCIs in the time domain, includes different PUCCHs in the PUCCHs of the at least two UCIs have the identical time domain resources.

In an implementation, overlapping of the plurality of PUCCHs in the time domain, includes the time domain resources of the PUCCHs of the at least two UCIs intersect. In other words, the time domain resource corresponding to each PUCCH includes a part of same time domain resources.

In the present example, when the at least two PUCCHs overlap in the time domain, the UCIs on the at least two PUCCHs is formed into the multiplexed UCI, and a PUCCH of UCI corresponding to a PF0 format and having a high priority is preferably used for sending the multiplexed UCI. This ensures that multiplexing process does not increase a transmission delay of the UCI having the high priority. Moreover, by utilizing a characteristic that a maximum carrying capacity (3 bits) of the PUCCH of the PF0 format is greater than a maximum carrying capacity (2 bits) of the PUCCH of the PF1 format, a capability to multiplex the UCI can be improved by using the PUCCH of the PF0 format to send the multiplexed UCI.

An example of the disclosure provides a method for sending uplink control information, performed by a user device. The method includes: in response to physical uplink control channels (PUCCHs) of at least two pieces of uplink control information (UCIs) overlapping in a time domain and the at least two UCIs including at least one UCI corresponding to a PUCCH format0 (PF0) format and having a high priority, multiplexed UCI is sent over a PUCCH of the PF0 format corresponding to any UCI in the at least one UCI corresponding to the PF0 format and having the high priority. Where the multiplexed UCI includes a cyclic shift state corresponding to a combination of the at least two UCIs. Information quantity of the combination of the at least two UCIs is less than or equal to 3 bits.

In the present example, when the at least two PUCCHs overlap in the time domain, the UCIs on the at least two PUCCHs is formed into the multiplexed UCI, and a PUCCH of UCI corresponding to a PF0 format and having a high priority is preferably used for sending the multiplexed UCI. This ensures that a multiplexing operation does not increase a transmission delay of the UCI having the high priority. Moreover, by utilizing a characteristic that a maximum carrying capacity (3 bits) of the PUCCH of the PF0 format is greater than a maximum carrying capacity (2 bits) of the PUCCH of the PF1 format, a capability to multiplex the UCI can be improved by using the PUCCH of the PF0 format to send the multiplexed UCI when information quantity of the combination of the at least two UCIs is less than or equal to 3 bits.

An example of the disclosure provides a method for sending uplink control information, performed by a user device. The method includes: sending, in response to physical uplink control channels (PUCCHs) of two pieces of uplink control information (UCIs) overlapping in a time domain and the two UCIs including an HP HARQ-ACK (PF0, 1 bit) and an HP SR (PF1, 1 bit), multiplexed UCI over a PUCCH of a PF0 format corresponding to the HP HARQ-ACK (PF0, 1 bit). Where the multiplexed UCI includes a cyclic shift state corresponding to a combination of the two UCIs.

The HP HARQ-ACK (PF0, 1 bit) represents an HARQ-ACK corresponding to a PF0 format and having a high priority, and the HARQ-ACK occupies 1 bit.

The HP SR (PF1, 1 bit) represents an SR corresponding to a PF1 format and having a high priority, and the SR occupies 1 bit.

The total bit occupied by the above two UCIs is 2 bits, and a mapping relationship between the cyclic shift state and the combination of the two UCIs is preset.

For example: a cyclic shift state 1 is used to represent (HP HARQ-ACK, HP SR)=(00); a cyclic shift state 2 is used to represent (HP HARQ-ACK, HP SR)=(01); a cyclic shift state 3 is used to represent (HP HARQ-ACK, HP SR)=(10); and a cyclic shift state 4 is used to represent (HP HARQ-ACK, HP SR)=(11).

In the present example, the UCI corresponding to the PF0 format and having the high priority in the two multiplexed UCIs is HP HARQ-ACK (PF0.1 bit), so that the multiplexed UCI is sent over the PUCCH of the PF0 format corresponding to the HP HARQ-ACK (PF0, 1 bit).

An example of the disclosure provides a method for sending uplink control information, performed by a user device. The method includes: sending, in response to physical uplink control channels (PUCCHs) of two pieces of uplink control information (UCIs) overlapping in a time domain and the two UCIs including an HP HARQ-ACK (PF0, 2 bit) and an HP SR (PF1, 1 bit), multiplexed UCI over a PUCCH of a PF0 format corresponding to the HP HARQ-ACK (PF0, 2 bit). Where the multiplexed UCI includes a cyclic shift state corresponding to a combination of the two UCIs.

The HP HARQ-ACK (PF0, 2 bit) represents an HARQ-ACK corresponding to a PF0 format and having a high priority, and the HARQ-ACK occupies 2 bits.

The HP SR (PF1, 1 bit) represents an SR corresponding to a PF1 format and having a high priority, and the SR occupies 1 bit.

The total bit occupied by the above two UCIs is 3 bits, and a mapping relationship between the cyclic shift state and the combination of the two UCIs is preset.

For example: a cyclic shift state 1 is used to represent (HP HARQ-ACK, HP SR)=(000); a cyclic shift state 2 is used to represent (HP HARQ-ACK, HP SR)=(001); a cyclic shift state 3 is used to represent (HP HARQ-ACK, HP SR)=(010); a cyclic shift state 4 is used to represent (HP HARQ-ACK, HP SR)=(011); a cyclic shift state 5 is used to represent (HP HARQ-ACK, HP SR)=(100); a cyclic shift state 6 is used to represent (HP HARQ-ACK, HP SR)=(101); a cyclic shift state 7 is used to represent (HP HARQ-ACK, HP SR)=(110); and a cyclic shift state 8 is used to represent (HP HARQ-ACK, HP SR)=(111).

In the present example, the UCI corresponding to the PF0 format and having the high priority in the two multiplexed UCIs is HP HARQ-ACK (PF0, 2 bit), so that the multiplexed UCI is sent over the PUCCH of the PF0 format corresponding to the HP HARQ-ACK (PF0, 2 bit).

An example of the disclosure provides a method for sending uplink control information, performed by a user device. The method includes: sending, in response to physical uplink control channels (PUCCHs) of two pieces of uplink control information (UCIs) overlapping in a time domain and the two UCIs including an HP HARQ-ACK (PF1, 1 bit) and an HP SR (PF0, 1 bit), multiplexed UCI over a PUCCH of a PF0 format corresponding to the HP SR (PF0, 1 bit). Where the multiplexed UCI includes a cyclic shift state corresponding to a combination of the two UCIs.

The HP HARQ-ACK (PF1, 1 bit) represents an HARQ-ACK corresponding to a PF1 format and having a high priority, and the HARQ-ACK occupies 1 bit.

The HP SR (PF0, 1 bit) represents an SR corresponding to a PF0 format and having a high priority, and the SR occupies 1 bit.

The total bit occupied by the above two UCIs is 2 bits, and a mapping relationship between the cyclic shift state and the combination of the two UCIs is preset. For example: a cyclic shift state 1 is used to represent (HP HARQ-ACK, HP SR)=(00); a cyclic shift state 2 is used to represent (HP HARQ-ACK, HP SR)=(01); a cyclic shift state 3 is used to represent (HP HARQ-ACK, HP SR)=(10); and a cyclic shift state 4 is used to represent (HP HARQ-ACK, HP SR)=(11).

In the present example, the UCI corresponding to the PF0 format and having the high priority in the two multiplexed UCIs is the HP SR (PF0, 1 bit), so that the multiplexed UCI is sent over the PUCCH of the PF0 format corresponding to the HP SR (PF0, 1 bit).

An example of the disclosure provides a method for sending uplink control information, performed by a user device. The method includes:
sending, in response to physical uplink control channels (PUCCHs) of two pieces of uplink control information (UCIs) overlapping in a time domain and the two UCIs including an HP HARQ-ACK (PF1, 2 bit) and an HP SR (PF0, 1 bit), multiplexed UCI over a PUCCH of a PF0 format corresponding to the HP SR (PF0, 1 bit). Where the multiplexed UCI includes a cyclic shift state corresponding to a combination of the two UCIs.

The HP HARQ-ACK (PF1, 2 bit) represents an HARQ-ACK corresponding to a PF1 format and having a high priority, and the HARQ-ACK occupies 2 bits.

The HP SR (PF0, 1 bit) represents an SR corresponding to a PF0 format and having a high priority, and the SR occupies 1 bit.

The total bit occupied by the above two UCIs is 3 bits, and a mapping relationship between the cyclic shift state and the combination of the two UCIs is preset. For example:
a cyclic shift state 1 is used to represent (HP HARQ-ACK, HP SR)=(000)
a cyclic shift state 2 is used to represent (HP HARQ-ACK, HP SR)=(001)
a cyclic shift state 3 is used to represent (HP HARQ-ACK, HP SR)=(010)
a cyclic shift state 4 is used to represent (HP HARQ-ACK, HP SR)=(011)
a cyclic shift state 5 is used to represent (HP HARQ-ACK, HP SR)=(100)
a cyclic shift state 6 is used to represent (HP HARQ-ACK, HP SR)=(101)
a cyclic shift state 7 is used to represent (HP HARQ-ACK, HP SR)=(110)
a cyclic shift state 8 is used to represent (HP HARQ-ACK, HP SR)=(111)

In the present example, the UCI corresponding to the PF0 format and having the high priority in the two multiplexed UCIs is the HP SR (PF0, 1 bit), so that the multiplexed UCI is sent over the PUCCH of the PF0 format corresponding to the HP SR (PF0, 1 bit).

An example of the disclosure provides a method for sending uplink control information, performed by a user device. The method includes: sending, in response to physical uplink control channels (PUCCHs) of at least two pieces of uplink control information (UCIs) overlapping in a time domain and the at least two UCIs including at least one UCI corresponding to a PF0 format and having a high priority and at least one UCI having a low priority, multiplexed UCI over a PUCCH of the PF0 format corresponding to any UCI in the at least one UCI corresponding to the PF0 format and having the high priority. Where the multiplexed UCI includes a cyclic shift state corresponding to a combination of the at least two UCIs.

In an implementation, the at least one UCI having the low priority includes at least one of: UCI corresponding to a PF0 format and having the low priority, or UCI corresponding to a PF1 format and having the low priority.

In the present example, when the at least two PUCCHs overlap in the time domain and the at least two PUCCHs include both the UCI having the high priority and the UCI having the low priority, the UCIs on the at least two PUCCHs is formed into the multiplexed UCI, and a PUCCH of the UCI corresponding to the PF0 format and having the high priority is preferably used for sending the multiplexed UCI. This ensures that a multiplexing operation does not increase a transmission delay of the UCI having the high priority. Moreover, by utilizing a characteristic that a maximum carrying capacity (3 bits) of the PUCCH of the PF0 format is greater than a maximum carrying capacity (2 bits) of the PUCCH of the PF1 format, a capability to multiplex the UCI can be improved by selecting to use the PUCCH of the PF0 format to send the multiplexed UCI.

An example of the disclosure provides a method for sending uplink control information, performed by a user device. The method includes: sending, in response to physical uplink control channels (PUCCHs) of two pieces of uplink control information (UCIs) overlapping in a time domain and the two UCIs including an HP SR (PF0, 1 bit) and an LP HARQ-ACK (PFX, 1 bit), multiplexed UCI over a PUCCH of a PF0 format corresponding to the HP SR (PF0, 1 bit). Where the multiplexed UCI includes a cyclic shift state corresponding to a combination of the two UCIs.

The HP SR (PF0, 1 bit) represents an SR corresponding to a PF0 format and having a high priority, and the SR occupies 1 bit.

The LP HARQ-ACK (PFX, 1 bit) represents an HARQ-ACK corresponding to the PF0 format and having a low priority, or an HARQ-ACK corresponding to the PF1 format and having a low priority, where a value of X is 0 or 1, and the HARQ-ACK occupies 1 bit.

The total bit occupied by the above two UCIs is 2 bits, and a mapping relationship between the cyclic shift state and the combination of the two UCIs is preset. For example: a cyclic shift state 1 is used to represent (HP SR, LP HARQ-ACK)=(00); a cyclic shift state 2 is used to represent (HP SR, LP HARQ-ACK)=(01); a cyclic shift state 3 is used to represent (HP SR, LP HARQ-ACK)=(10); and a cyclic shift state 4 is used to represent (HP SR, LP HARQ-ACK)=(11).

In the present example, the UCI corresponding to the PF0 format and having the high priority in the two multiplexed UCIs is HP SR (PF0, 1 bit), so that the multiplexed UCI is sent over the PUCCH of the PF0 format corresponding to the HP SR (PF0, 1 bit).

An example of the disclosure provides a method for sending uplink control information, performed by a user device. The method includes: sending, in response to physical uplink control channels (PUCCHs) of two pieces of uplink control information (UCIs) overlapping in a time domain and the two UCIs including an HP HARQ-ACK (PF0, 2 bit) and an LP HARQ-ACK (PFX, 1 bit), multiplexed UCI over a PUCCH of a PF0 format corresponding to the HP HARQ-ACK (PF0, 2 bit). Where the multiplexed UCI includes a cyclic shift state corresponding to a combination of the two UCIs.

The HP HARQ-ACK (PF0, 2 bit) represents an HARQ-ACK corresponding to a PF0 format and having a high priority, and the HARQ-ACK occupies 2 bits.

The LP HARQ-ACK (PFX, 1 bit) represents an HARQ-ACK corresponding to the PF0 format and having a low priority, or an HARQ-ACK corresponding to the PF1 format and having a low priority, where a value of X is 0 or 1, and the HARQ-ACK occupies 1 bit.

The total bit occupied by the above two UCIs is 3 bits, and a mapping relationship between the cyclic shift state and the combination of the two UCIs is preset. For example: a cyclic shift state 1 is used to represent (HP HARQ-ACK, LP HARQ-ACK)=(000); a cyclic shift state 2 is used to represent (HP HARQ-ACK, LP HARQ-ACK)=(001); a cyclic shift state 3 is used to represent (HP HARQ-ACK, LP HARQ-ACK)=(010); a cyclic shift state 4 is used to represent (HP HARQ-ACK, LP HARQ-ACK)=(011); a cyclic shift state 5 is used to represent (HP HARQ-ACK, LP HARQ-ACK)=(100); a cyclic shift state 6 is used to represent (HP HARQ-ACK, LP HARQ-ACK)=(101); a cyclic shift state 7 is used to represent (HP HARQ-ACK, LP HARQ-ACK)=(110); and a cyclic shift state 8 is used to represent (HP HARQ-ACK, LP HARQ-ACK)=(111).

In the present example, the UCI corresponding to the PF0 format and having the high priority in the two multiplexed UCIs is HP HARQ-ACK (PF0, 2 bit), so that the multiplexed UCI is sent over the PUCCH of the PF0 format corresponding to the HP HARQ-ACK (PF0, 2 bit).

An example of the disclosure provides a method for sending uplink control information, performed by a user device. The method includes: sending, in response to physical uplink control channels (PUCCHs) of three pieces of uplink control information (UCIs) overlapping in a time domain and the three UCIs including an HP HARQ-ACK (PF1, 1 bit), an HP SR (PF0, 1 bit) and UCI having a low priority, multiplexed UCI over a PUCCH of a PF0 format corresponding to the HP SR (PF0, 1 bit). Where the multiplexed UCI includes a cyclic shift state corresponding to a combination of the three UCIs.

The HP HARQ-ACK (PF1, 1 bit) represents an HARQ-ACK corresponding to a PF1 format and having a high priority, and the HARQ-ACK occupies 1 bit.

The HP SR (PF0, 1 bit) represents an SR corresponding to a PF0 format and having a high priority, and the SR occupies 1 bit.

The UCI having the low priority is an LP HARQ-ACK (PF0, 1 bit), an LP HARQ-ACK (PF1, 1 bit), an LP SR (PF0, 1 bit), or an LP SR (PF1, 1 bit).

The total bit occupied by the above three UCIs is 3 bits, and a mapping relationship between the cyclic shift state and the combination of the three UCIs is preset. For example: a cyclic shift state 1 is used to represent (HP HARQ-ACK, HP SR, UCI having the low priority)=(000); a cyclic shift state 2 is used to represent (HP HARQ-ACK, HP SR, UCI having the low priority)=(001); a cyclic shift state 3 is used to represent (HP HARQ-ACK, HP SR, UCI having the low priority)=(010); a cyclic shift state 4 is used to represent (HP HARQ-ACK, HP SR, UCI having the low priority)=(011); a cyclic shift state 5 is used to represent (HP HARQ-ACK, HP SR, UCI having the low priority)=(100); a cyclic shift state 6 is used to represent (HP HARQ-ACK, HP SR, UCI having the low priority)=(101); a cyclic shift state 7 is used to represent (HP HARQ-ACK, HP SR, UCI having the low priority)=(110); and a cyclic shift state 8 is used to represent (HP HARQ-ACK, HP SR, UCI having the low priority)=(111).

In the present example, the UCI corresponding to the PF0 format and having the high priority in the three multiplexed UCIs is HP SR (PF0, 1 bit), so that the multiplexed UCI is sent over the PUCCH of the PF0 format corresponding to the HP SR (PF0, 1 bit).

An example of the disclosure provides a method for sending uplink control information, performed by a user device. The method includes: sending, in response to physical uplink control channels (PUCCHs) of three pieces of uplink control information (UCIs) overlapping in a time domain and the three UCIs including an HP HARQ-ACK (PF0, 1 bit), an HP SR (PF1, 1 bit) and UCI having a low priority, multiplexed UCI over a PUCCH of a PF0 format corresponding to the HP HARQ-ACK (PF0, 1 bit). Where the multiplexed UCI includes a cyclic shift state corresponding to a combination of the three UCIs.

The HP HARQ-ACK (PF0, 1 bit) represents an HARQ-ACK corresponding to a PF0 format and having a high priority, and the HARQ-ACK occupies 1 bit.

The HP SR (PF0, 1 bit) represents an SR corresponding to a PF0 format and having a high priority, and the SR occupies 1 bit.

The UCI having the low priority is an LP HARQ-ACK (PF0, 1 bit), an LP HARQ-ACK (PF1, 1 bit), an LP SR (PF0, 1 bit), or an LP SR (PF1, 1 bit).

The total bit occupied by the above three UCIs is 3 bits, and a mapping relationship between the cyclic shift state and the combination of the three UCIs is preset. For example: a cyclic shift state 1 is used to represent (HP HARQ-ACK, HP SR, UCI having the low priority)=(000); a cyclic shift state 2 is used to represent (HP HARQ-ACK, HP SR, UCI having the low priority)=(001); a cyclic shift state 3 is used to represent (HP HARQ-ACK, HP SR, UCI having the low priority)=(010); a cyclic shift state 4 is used to represent (HP HARQ-ACK, HP SR, UCI having the low priority)=(011); a cyclic shift state 5 is used to represent (HP HARQ-ACK, HP SR, UCI having the low priority)=(100); a cyclic shift state 6 is used to represent (HP HARQ-ACK, HP SR, UCI having the low priority)=(101); a cyclic shift state 7 is used to represent (HP HARQ-ACK, HP SR, UCI having the low priority)=(110); and a cyclic shift state 8 is used to represent (HP HARQ-ACK, HP SR, UCI having the low priority)=(111).

In the present example, the UCI corresponding to the PF0 format and having the high priority in the three multiplexed UCIs is HP HARQ-ACK (PF0, 1 bit), so that the multiplexed UCI is sent over the PUCCH of the PF0 format corresponding to the HP HARQ-ACK (PF0, 1 bit).

An example of the disclosure provides a method for sending uplink control information, performed by a user device. The method includes: in response to physical uplink control channels (PUCCHs) of at least two pieces of uplink control information (UCIs) overlapping in a time domain, and the at least two UCIs including at least one of: a hybrid automatic repeat request ACK (HARQ-ACK) corresponding to a PF0 format and having a high priority, or a scheduling request (SR) corresponding to the PF0 format and having a high priority, sending multiplexed UCI over a PUCCH of a PF0 format corresponding to the HARQ-ACK corresponding to the PF0 format and having the high priority; and, sending the multiplexed UCI over a PUCCH of a PF0 format corresponding to the SR corresponding to the PF0 format and having the high priority.

In the present example, when the at least two UCIs include both the hybrid automatic repeat request ACK (HARQ-ACK) corresponding to the PF0 format and having the high priority, and the scheduling request (SR) corresponding to the PF0 format and having the high priority, either of two is selected, and the multiplexed UCI is sent on a PUCCH of the selected UCI.

An example of the disclosure provides a method for sending uplink control information, performed by a user device. The method includes: sending, in response to physical uplink control channels (PUCCHs) of three pieces of uplink control information (UCIs) overlapping in a time domain and the three UCIs including an HP HARQ-ACK (PF0, 1 bit), an HP SR (PF0, 1 bit) and an LP HARQ-ACK (PFX, 1 bit), multiplexed UCI over a PUCCH of a PF0 format corresponding to the HP HARQ-ACK (PF0, 1 bit) or the multiplexed UCI over a PUCCH of a PF0 format corresponding to the HP SR (PF0, 1 bit). Where the multiplexed UCI includes a cyclic shift state corresponding to a combination of the three UCIs.

The HP HARQ-ACK (PF0, 1 bit) represents an HARQ-ACK corresponding to a PF0 format and having a high priority, and the HARQ-ACK occupies 1 bit.

The HP SR (PF0, 1 bit) represents an SR corresponding to a PF0 format and having a high priority, and the SR occupies 1 bit.

The LP HARQ-ACK (PFX, 1 bit) represents an HARQ-ACK corresponding to the PF0 format and having a low priority, or an HARQ-ACK corresponding to the PF1 format and having a low priority, where a value of X is 0 or 1, and the HARQ-ACK occupies 1 bit.

The total bit occupied by the above three UCIs is 3 bits, and a mapping relationship between the cyclic shift state and the combination of the three UCIs is preset. For example: a cyclic shift state 1 is used to represent (HP HARQ-ACK, HP SR, LP HARQ-ACK)=(000); a cyclic shift state 2 is used to represent (HP HARQ-ACK, HP SR, LP HARQ-ACK)=(001); a cyclic shift state 3 is used to represent (HP HARQ-ACK, HP SR, LP HARQ-ACK)=(010); a cyclic shift state 4 is used to represent (HP HARQ-ACK, HP SR, LP HARQ-ACK)=(011); a cyclic shift state 5 is used to represent (HP HARQ-ACK, HP SR, LP HARQ-ACK)=(100); a cyclic shift state 6 is used to represent (HP HARQ-ACK, HP SR, LP HARQ-ACK)=(101); a cyclic shift state 7 is used to represent (HP HARQ-ACK, HP SR, LP HARQ-ACK)=(110); and a cyclic shift state 8 is used to represent (HP HARQ-ACK, HP SR, LP HARQ-ACK)=(111).

In the present example, the UCI corresponding to the PF0 format and having the high priority in the three multiplexed UCIs includes HP HARQ-ACK (PF0, 1 bit) and HP SR (PF0, 1 bit), so that the multiplexed UCI is selected to be sent over the PUCCH of the PF0 format corresponding to one of the HP HARQ-ACK (PF0, 1 bit) and the HP SR (PF0, 1 bit).

An example of the disclosure provides a method for sending uplink control information, performed by a user device. The method includes: sending, in response to physical uplink control channels (PUCCHs) of at least two pieces of uplink control information (UCIs) overlapping in a time domain and the at least two UCIs including at least two UCIs corresponding to a PF0 format and having a high priority, multiplexed UCI over a PUCCH of the PF0 format corresponding to UCI with an earlier end time or an earlier start time in the at least two UCIs corresponding to the PF0 format and having the high priority. Where the multiplexed UCI includes a cyclic shift state corresponding to a combination of the at least two UCIs.

In the present example, when the at least two UCIs include both the hybrid automatic repeat request ACK (HARQ-ACK) corresponding to the PF0 format and having the high priority, and the scheduling request (SR) corresponding to the PF0 format and having the high priority, the UCI with the earlier end time or the earlier start time is selected from the two, and the multiplexed UCI is sent over a PUCCH of the selected UCI.

An example of the disclosure provides a method for sending uplink control information, performed by a user device. The method includes: sending, in response to physical uplink control channels (PUCCHs) of at least two pieces of uplink control information (UCIs) overlapping in a time domain, and the at least two UCIs including at least one of: a hybrid automatic repeat request ACK (HARQ-ACK) corresponding to a PF0 format and having a high priority, or a scheduling request (SR) corresponding to the PF0 format and having a high priority, multiplexed UCI over a PUCCH of a PF0 format corresponding to UCI with an earlier end time in the HARQ-ACK and the SR.

An example of the disclosure provides a method for sending uplink control information, performed by a user device. The method includes: sending, in response to physical uplink control channels (PUCCHs) of at least two pieces of uplink control information (UCIs) overlapping in a time domain, and the at least two UCIs including at least one of: a hybrid automatic repeat request ACK (HARQ-ACK) corresponding to a PF0 format and having a high priority, or a scheduling request (SR) corresponding to the PF0 format and having a high priority, multiplexed UCI over a PUCCH of a PF0 format corresponding to UCI with an earlier start time in the HARQ-ACK and the SR.

An example of the disclosure provides a method for sending uplink control information, performed by a user device. Referring to FIG. 2, FIG. 2 is a flow diagram of a method for sending uplink control information shown according to an example. As shown in FIG. 2, the method includes step S21.

In step S21, in response to physical uplink control channels (PUCCHs) of at least three pieces of uplink control information (UCIs) overlapping in a time domain, and the at least three UCIs at least including: a hybrid automatic repeat request ACK (HARQ-ACK) corresponding to a PUCCH format1 (PF1) format and having a high priority, a scheduling request (SR) corresponding to the PF1 format and having a high priority, and UCI corresponding to a PUCCH format0 (PF0) format or the PF1 format and having a low priority, when determining that a value of the SR is a positive value, multiplexed UCI is sent over a PUCCH of the SR corresponding to the PF1 format and having the high priority. Where the multiplexed UCI is a combination of the HARQ-ACK corresponding to the PF1 format and having the high priority and the UCI corresponding to the PF0 format or the PF1 format and having the low priority, and the number of bits of the multiplexed UCI is 2. And when determining that the value of the SR is a negative value, the multiplexed UCI is sent over a PUCCH of the HARQ-ACK corresponding to the PF1 format and having the high priority, where the multiplexed UCI is a combination of the HARQ-ACK corresponding to the PF1 format and having the high priority and an HARQ-ACK corresponding to the PF0 format or the PF1 format and having a low priority. The number of bits of the multiplexed UCI is 2.

In an implementation, the UCI corresponding to the PF0 format or the PF1 format and having the low priority includes one of: the HARQ-ACK corresponding to the PF0 format and having the low priority, the HARQ-ACK corresponding to the PF1 format and having the low priority, a scheduling request (SR) corresponding to the PF0 format and having a low priority, or a scheduling request (SR) corresponding to the PF1 format and having a low priority.

In the present example, considering that a maximum carrying capacity of the PUCCH of the PF1 format is 2 bits, it is not possible to multiplex three UCIs. Different processing is performed according to specific values of the SRs of the three UCIs. When the value of the SR is the positive value, the multiplexed UCI is sent over the PUCCH corresponding to the SR to represent that the value of the SR is the positive value, and the other two UCIs are multiplexed. When the value of the SR is the negative value, the SR is ignored, the multiplexed UCI is sent over the PUCCH corresponding to the SR to indicate that the value of the SR is the positive value, the other two UCIs are multiplexed, and the multiplexed UCI is sent over the HARQ-ACK having the high priority.

An example of the disclosure provides a method for sending uplink control information, performed by a user device. The method includes: in response to physical uplink control channels (PUCCHs) of three pieces of uplink control information (UCIs) overlapping in a time domain and the three UCIs including an HP HARQ-ACK (PF1, 1 bit), an HP SR (PF1, 1 bit) and an LP HARQ-ACK (PF0, 1 bit), when determining that HP SR (PF1, 1 bit) is a positive value, sending multiplexed UCI over a PUCCH corresponding to the HP SR (PF1, 1 bit). Where the multiplexed UCI is a combination of the HP HARQ-ACK (PF1, 1 bit) and the LP HARQ-ACK (PF0, 1 bit). And when determining that the HP SR (PF1, 1 bit) is a negative value, sending the multiplexed UCI over a PUCCH corresponding to the HP HARQ-ACK (PF1, 1 bit). Where the multiplexed UCI is a combination of the HP HARQ-ACK (PF1, 1 bit) and the LP HARQ-ACK (PF0, 1 bit).

The HP HARQ-ACK (PF1, 1 bit) represents an HARQ-ACK corresponding to a PF0 format and having a high priority, and the HARQ-ACK occupies 1 bit.

The HP SR (PF1, 1 bit) represents an SR corresponding to a PF0 format and having a high priority, and the SR occupies 1 bit.

The LP HARQ-ACK (PF0, 1 bit) represents an HARQ-ACK corresponding to a PF0 format and having a low priority, and the HARQ-ACK occupies 1 bit.

An example of the disclosure provides a method for sending uplink control information, performed by a user device. The method includes: in response to physical uplink control channels (PUCCHs) of three pieces of uplink control information (UCIs) overlapping in a time domain and the three UCIs including an HP HARQ-ACK (PF1, 1 bit), an HP SR (PF1, 1 bit) and an LP HARQ-ACK (PF1, 1 bit), sending, in response to determining that HP SR (PF1, 1 bit) is a positive value, multiplexed UCI over a PUCCH corresponding to the HP SR (PF1, 1 bit). Where the multiplexed UCI is a combination of the HP HARQ-ACK (PF1, 1 bit) and the LP HARQ-ACK (PF1, 1 bit). And sending, in response to determining that the HP SR (PF1, 1 bit) is a negative value, the multiplexed UCI over a PUCCH corresponding to the HP HARQ-ACK (PF1, 1 bit). Where the multiplexed UCI is a combination of the HP HARQ-ACK (PF1, 1 bit) and the LP HARQ-ACK (PF1, 1 bit).

The HP HARQ-ACK (PF1, 1 bit) represents an HARQ-ACK corresponding to a PF0 format and having a high priority, and the HARQ-ACK occupies 1 bit.

The HP SR (PF1, 1 bit) represents an SR corresponding to a PF0 format and having a high priority, and the SR occupies 1 bit.

The LP HARQ-ACK (PF1, 1 bit) represents an HARQ-ACK corresponding to a PF1 format and having a low priority, and the HARQ-ACK occupies 1 bit.

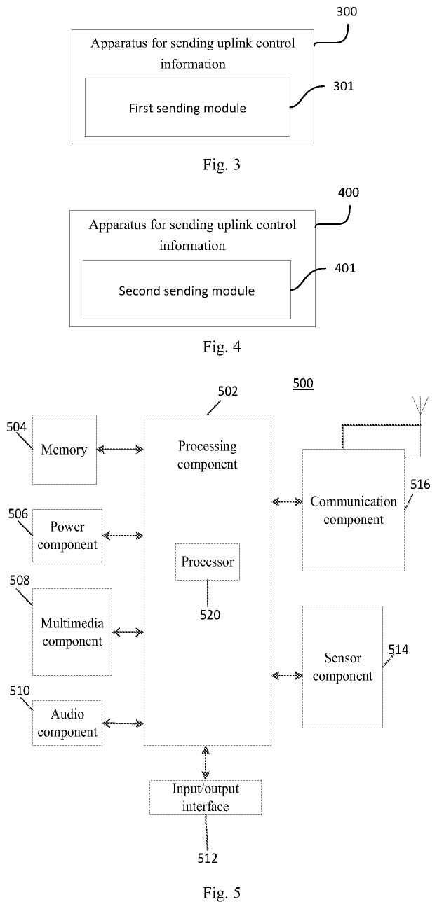

An example of the disclosure provides an apparatus for sending uplink control information 300, performed by a user device. Referring to FIG. 3, FIG. 3 is a structural diagram of an apparatus for sending uplink control information 300 shown according to an example. As shown in FIG. 3, the apparatus 300 includes a first sending module 301.

The first sending module 301 is configured to send, in response to physical uplink control channels (PUCCHs) of at least two pieces of uplink control information (UCIs) overlapping in a time domain and the at least two UCIs including at least one UCI corresponding to a PUCCH format0 (PF0) format and having a high priority, multiplexed UCI over a PUCCH of the PF0 format corresponding to any UCI in the at least one UCI corresponding to the PF0 format and having the high priority. The multiplexed UCI includes a cyclic shift state corresponding to a combination of the at least two UCIs.

An example of the disclosure provides the apparatus for sending uplink control information 300, performed by a user device. Where the first sending module 301 is configured to send, in response to physical uplink control channels (PUCCHs) of at least two pieces of uplink control information (UCIs) overlapping in a time domain and the at least two UCIs including at least one UCI corresponding to a PUCCH format0 (PF0) format and having a high priority, multiplexed UCI over a PUCCH of the PF0 format corresponding to any UCI in the at least one UCI corresponding to the PF0 format and having the high priority. The multiplexed UCI includes a cyclic shift state corresponding to a combination of the at least two UCIs. Information quantity of the combination of the at least two UCIs is less than or equal to 3 bits.

An example of the disclosure provides the apparatus for sending uplink control information 300, performed by a user device. Where the first sending module 301 is configured to send, in response to physical uplink control channels (PUCCHs) of at least two pieces of uplink control information (UCIs) overlapping in a time domain and the at least two UCIs including at least one UCI corresponding to a PUCCH format0 (PF0) format and having a high priority, multiplexed UCI over a PUCCH of the PF0 format corresponding to any UCI in the at least one UCI corresponding to the PF0 format and having the high priority. Where the multiplexed UCI includes a cyclic shift state corresponding to a combination of the at least two UCIs. The at least two UCIs further include at least one UCI having a low priority.

An example of the disclosure provides an apparatus for sending uplink control information 300, performed by a user device. Where the a first sending module 301, configured to send, in response to physical uplink control channels (PUCCHs) of at least two pieces of uplink control information (UCIs) overlapping in a time domain and the at least two UCIs including at least one UCI corresponding to a PUCCH format0 (PF0) format and having a high priority, multiplexed UCI over a PUCCH of the PF0 format corresponding to any UCI in the at least one UCI corresponding to the PF0 format and having the high priority. The multiplexed UCI includes a cyclic shift state corresponding to a combination of the at least two UCIs. The at least two UCIs further include at least one UCI having a low priority.

The at least one UCI having the low priority includes at least one of: UCI corresponding to a PF0 format and having the low priority, or UCI corresponding to a PF1 format and having the low priority.

An example of the disclosure provides the apparatus for sending uplink control information 300, performed by a user device. Where the first sending module 301 is configured to: send, in response to physical uplink control channels (PUCCHs) of at least two pieces of uplink control information (UCIs) overlapping in a time domain, and the at least two UCIs include at least one of: a hybrid automatic repeat request ACK (HARQ-ACK) corresponding to a PUCCH format0 (PF0) format and having a high priority, or a scheduling request (SR) corresponding to the PF0 format and having a high priority, multiplexed UCI over a PUCCH of a PF0 format corresponding to the HARQ-ACK corresponding to the PF0 format and having the high priority, or the multiplexed UCI over a PUCCH of a PF0 format corresponding to the SR corresponding to the PF0 format and having the high priority. The multiplexed UCI includes a cyclic shift state corresponding to a combination of at least two UCIs.

In an implementation, the at least two UCIs further include at least one UCI having a low priority.

In an implementation, information quantity of the combination of the at least two UCIs is less than or equal to 3 bits.

In an implementation, the at least two UCIs further include: an HARQ-ACK corresponding to the PF0 format and having a low priority, or an HARQ-ACK corresponding to the PF1 format and having a low priority.

In an implementation, the at least two UCIs further include: an SR corresponding to the PF0 format and having a low priority, or an SR corresponding to the PF1 format and having a low priority.

In an implementation, the at least two UCIs further include one of: the HARQ-ACK corresponding to the PF0 format and having the low priority, an HARQ-ACK corresponding to the PF1 format and having a low priority; and the at least two UCIs further include one of the following: an SR corresponding to the PF0 format and having a low priority, or an SR corresponding to the PF1 format and having a low priority.

An example of the disclosure provides an apparatus for sending uplink control information 400, performed by a user device. Referring to FIG. 4, FIG. 4 is a structural diagram of an apparatus for sending uplink control information 400 shown according to an example. As shown in FIG. 4, the apparatus 400 includes a second sending module 401.

The second sending module 401 is configured to: in response to physical uplink control channels (PUCCHs) of at least three pieces of uplink control information (UCIs) overlapping in a time domain, and the at least three UCIs at least including: a hybrid automatic repeat request ACK (HARQ-ACK) corresponding to a PUCCH format1 (PF1) format and having a high priority, a scheduling request (SR) corresponding to the PF1 format and having a high priority, and UCI corresponding to a PUCCH format0 (PF0) format or the PF1 format and having a low priority, determining that a value of the SR is a positive value or a negative value. When determining that a value of the SR is a positive value, send multiplexed UCI over a PUCCH of the SR corresponding to the PF1 format and having the high priority, where the multiplexed UCI is a combination of the HARQ-ACK corresponding to the PF1 format and having the high priority and the UCI corresponding to the PF0 format or the PF1 format and having the low priority. When determining that the value of the SR is a negative value, send the multiplexed UCI over a PUCCH of the HARQ-ACK corresponding to the PF1 format and having the high priority, where the multiplexed UCI is a combination of the HARQ-ACK corresponding to the PF1 format and having the high priority and an HARQ-ACK corresponding to the PF0 format or the PF1 format and having a low priority.

In an implementation, the UCI corresponding to the PF0 format or the PF1 format and having the low priority includes one of: the HARQ-ACK corresponding to the PF0 format and having the low priority, the HARQ-ACK corresponding to the PF1 format and having the low priority, a scheduling request (SR) corresponding to the PF0 format and having a low priority, or a scheduling request (SR) corresponding to the PF1 format and having a low priority.

An example of the disclosure provides a user device, including: a processor; and a memory, used for storing executable instructions of the processor. Where the processor is configured to execute the executable instructions in the memory so as to implement steps of the method for sending the uplink control information.

An example of the disclosure provides a non-transitory computer-readable storage medium, storing executable instructions, the executable instructions, when executed by a processor, implementing steps of the method for sending the uplink control information.

FIG. 5 is a block diagram of an apparatus 500 for sending uplink control information shown according to an example. For example, the apparatus 500 may be a mobile telephone, a computer, a digital broadcast terminal, a message transceiving device, a game console, a tablet device, a medical device, a fitness device, a personal digital assistant, and the like.

Referring to FIG. 5, the apparatus 500 may include one or more of the following components: a processing component 502, a memory 504, a power supply component 506, a multimedia component 508, an audio component 510, an input/output (I/O) interface 512, a sensor component 514, and a communication component 516.

The processing component 502 usually controls an overall operation of the apparatus 500, such as operations associated with displaying, telephone calling, data communication, a camera operation and a record operation. The processing component 502 may include one or more processors 520 to execute an instruction, so as to complete all or part of steps of the above methods. In addition, the processing component 502 may include one or more modules, so as to facilitate interaction between the processing component 502 and other components. For example, the processing component 502 may include a multimedia module, so as to facilitate interaction between the multimedia component 508 and the processing component 502.

The memory 504 is configured to store various types of data so as to support operations on the apparatus 500. Examples of these data include instructions of any application program or method used to be operated on the apparatus 500, contact data, telephone directory data, messages, pictures, videos, and the like. The memory 504 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 506 provides electric power for various components of the apparatus 500. The power supply component 506 may include a power management system, one or more power sources, and other components associated with generating, managing and distributing electric power for the apparatus 500.

The multimedia component 508 includes a screen providing an output interface between the apparatus 500 and a user. In some examples, the screen may include a liquid crystal display (LCD) and a touch panel (TP). In response to determining that the screen includes the touch panel, the screen may be implemented as a touch screen so as to receive an input signal from the user. The touch panel includes one or more touch sensors to sense touching, swiping and gestures on the touch panel. The touch sensor may not only sense a boundary of a touching or swiping action, but also detect duration and pressure related to the touching or swiping operation. In some examples, the multimedia component 508 includes a front camera and/or a rear camera. When the apparatus 500 is in an operation mode, such as a shooting mode or a video mode, the front camera and/or the rear camera may receive external multimedia data. Each front camera and each rear camera may be a fixed optical lens system or have a focal length and optical zooming capability.

The audio component 510 is configured to output and/or input an audio signal. For example, the audio component 510 includes a microphone (MIC). When the apparatus 500 is in an operation mode, such as a call mode, a recording mode or a speech recognition mode, the microphone is configured to receive an external audio signal. The received audio signal may be further stored in the memory 504 or sent via the communication component 516. In some examples, the audio component 510 further includes a speaker for outputting the audio signal.

The I/O interface 512 provides an interface between the processing component 502 and a peripheral interface module, and the above peripheral interface module may be a keyboard, a click wheel, buttons, etc. These buttons may include but are not limited to: a home button, a volume button, a start button and a lock button.

The sensor component 514 includes one or more sensors for providing state evaluations of all aspects for the apparatus 500. For example, the sensor component 514 may detect an on/off state of the apparatus 500 and relative positioning of components, for example, the components are a display and a keypad of the apparatus 500. The sensor component 514 may further detect position change of the apparatus 500 or one component of the apparatus 500, whether there is contact between the user and the apparatus 500, azimuth or speed up/speed down of the apparatus 500, and temperature change of the apparatus 500. The sensor component 514 may include a proximity sensor, which is configured to detect existence of a nearby object without any physical contact. The sensor component 514 may further include an optical sensor, such as a CMOS or CCD image sensor, for use in an imaging application. In some examples, the sensor component 514 may further include an acceleration sensor, a gyroscope sensor, a magnetic sensor, a pressure sensor or a temperature sensor.

The communication component 516 is configured to facilitate wired or wireless communication between the apparatus 500 and other devices. The apparatus 500 may access a wireless network based on a communication standard, such as WiFi, 2G or 3G, or their combination. In one example, the communication component 516 receives a broadcast signal or broadcast related information from an external broadcast management system via a broadcast channel. In an example, the communication component 516 may further include a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the apparatus 500 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the above method.

In the example, a non-transitory computer readable storage medium including instructions is further provided, such as a memory 504 including instructions. The above instructions may be executed by a processor 520 of the apparatus 500 so as to complete the above method. For example, the non-transitory computer readable storage medium may be an ROM, a random access memory (RAM), a CD-ROM, a magnetic tape, a floppy disk, an optical data storage device and the like.

According to a first aspect, an example of the disclosure provides a method for sending uplink control information, performed by a user device, the method including: sending, in response to physical uplink control channels (PUCCHs) of at least two pieces of uplink control information (UCIs) overlapping in a time domain and the at least two UCIs including at least one UCI corresponding to a PUCCH format0 (PF0) format and having a high priority, multiplexed UCI over a PUCCH of the PF0 format corresponding to any UCI in the at least one UCI corresponding to the PF0 format and having the high priority, where the multiplexed UCI includes a cyclic shift state corresponding to a combination of the at least two UCIs.

In an implementation, an information quantity of the combination of the at least two UCIs is less than or equal to 3 bits.

In an implementation, the at least two UCIs further include at least one UCI having a low priority.

In an implementation, the at least one UCI having the low priority includes at least one of: UCI corresponding to a PF0 format and having the low priority, or UCI corresponding to a PUCCH format1 (PF1) format and having the low priority.

In an implementation, the at least two UCIs include at least one of: a hybrid automatic repeat request ACK (HARQ-ACK) corresponding to the PF0 format and having a high priority, or a scheduling request (SR) corresponding to the PF0 format and having a high priority; and sending the multiplexed UCI over the PUCCH of the PF0 format corresponding to any UCI in the at least one UCI corresponding to the PF0 format and having the high priority includes: sending the multiplexed UCI over a PUCCH of a PF0 format corresponding to the HARQ-ACK corresponding to the PF0 format and having the high priority.

In an implementation, the at least two UCIs include at least one of: a hybrid automatic repeat request ACK (HARQ-ACK) corresponding to the PF0 format and having a high priority, or a scheduling request (SR) corresponding to the PF0 format and having a high priority; and sending the multiplexed UCI over the PUCCH of the PF0 format corresponding to any UCI in the at least one UCI corresponding to the PF0 format and having the high priority includes: sending the multiplexed UCI over a PUCCH of a PF0 format corresponding to the SR corresponding to the PF0 format and having the high priority.

In an implementation, the at least two UCIs further include: an HARQ-ACK corresponding to the PF0 format and having a low priority, or an HARQ-ACK corresponding to a PUCCH format1 (PF1) format and having a low priority.

In an implementation, the at least two UCIs further include: an SR corresponding to a PUCCH format1 (PF1) format and having a low priority, or an SR corresponding to a PUCCH format1 (PF1) format and having a low priority.

In an implementation, the at least two UCIs further include one of: an HARQ-ACK corresponding to the PF0 format and having a low priority, an HARQ-ACK corresponding to a PUCCH format1 (PF1) format and having a low priority; and the at least two UCIs further include one of: an SR corresponding to the PF0 format and having a low priority, or an SR corresponding to the PF1 format and having a low priority.

According to a second aspect, an example of the disclosure provides a method for sending uplink control information, performed by a user device, the method including: in response to physical uplink control channels (PUCCHs) of at least three pieces of uplink control information (UCIs) overlapping in a time domain, and the at least three UCIs at least including: hybrid automatic repeat request ACK (HARQ-ACK) corresponding to a PF1 format and having a high priority, a scheduling request (SR) corresponding to the PF1 format and having a high priority, and UCI corresponding to a PF0 format or the PF1 format and having a low priority, when determining that a value of the SR is a positive value, sending multiplexed UCI over a PUCCH of the SR corresponding to the PF1 format and having the high priority, where the multiplexed UCI is a combination of the HARQ-ACK corresponding to the PF1 format and having the high priority and the UCI corresponding to the PF0 format or the PF1 format and having the low priority; and when determining that the value of the SR is a negative value, sending the multiplexed UCI over a PUCCH of the HARQ-ACK corresponding to the PF1 format and having the high priority, where the multiplexed UCI is a combination of the HARQ-ACK corresponding to the PF1 format and having the high priority and an HARQ-ACK corresponding to the PF0 format or the PF1 format and having a low priority.

In an implementation, the UCI corresponding to the PF0 format or the PF1 format and having the low priority includes one of: an HARQ-ACK corresponding to the PF0 format and having a low priority, an HARQ-ACK corresponding to the PF1 format and having a low priority, an SR corresponding to the PF0 format and having a low priority, or an SR corresponding to the PF1 format and having a low priority.

According to a third aspect, an example of the disclosure provides an apparatus for sending uplink control information, performed by a user device, the method including: a first sending module, configured to send, in response to physical uplink control channels (PUCCHs) of at least two pieces of uplink control information (UCIs) overlapping in a time domain and the at least two UCIs including at least one UCI corresponding to a PUCCH format0 (PF0) format and having a high priority, multiplexed UCI over a PUCCH of the PF0 format corresponding to any UCI in the at least one UCI corresponding to the PF0 format and having the high priority, where the multiplexed UCI includes a cyclic shift state corresponding to a combination of the at least two UCIs.

In an implementation, the at least two UCIs further include at least one UCI having a low priority.

In an implementation, the at least one UCI having the low priority includes at least one of: UCI corresponding to a PF0 format and having the low priority, or UCI corresponding to a PF1 format and having the low priority.

According to a fourth aspect, an example of the disclosure provides an apparatus for sending uplink control information, performed by a user device, the apparatus including: a second sending module, configured to: in response to physical uplink control channels (PUCCHs) of at least three pieces of uplink control information (UCIs) overlapping in a time domain, and the at least three UCIs at least including: hybrid automatic repeat request ACK (HARQ-ACK) corresponding to a PUCCH format1 (PF1) format and having a high priority, a scheduling request (SR) corresponding to the PF1 format and having a high priority, and UCI corresponding to a PUCCH format0 (PF0) format or the PF1 format and having a low priority, when determining that a value of the SR is a positive value, send multiplexed UCI over a PUCCH of the SR corresponding to the PF1 format and having the high priority, where the multiplexed UCI is a combination of the HARQ-ACK corresponding to the PF1 format and having the high priority and the UCI corresponding to the PF0 format or the PF1 format and having the low priority; and when determining that the value of the SR is a negative value, send the multiplexed UCI over a PUCCH of the HARQ-ACK corresponding to the PF1 format and having the high priority, where the multiplexed UCI is a combination of the HARQ-ACK corresponding to the PF1 format and having the high priority and an HARQ-ACK corresponding to the PF0 format or the PF1 format and having a low priority.

In an implementation, the UCI corresponding to the PF0 format or the PF1 format and having the low priority includes one of: an HARQ-ACK corresponding to the PF0 format and having a low priority, an HARQ-ACK corresponding to the PF1 format and having a low priority, an SR corresponding to the PF0 format and having a low priority, or an SR corresponding to the PF1 format and having a low priority.

The technical solution provided by the examples of the disclosure may include the following beneficial effects: when the at least two PUCCH channels overlap in the time domain, the PUCCH of the UCI having the high priority is preferably used for sending the multiplexed UCI, which can ensure that multiplexing processing does not increase a transmission delay of the UCI having the high priority.

Those skilled in the art will easily figure out other implementation solutions of the examples of the disclosure after considering the specification and practicing the invention disclosed here. The present disclosure intends to cover any transformation, usage or adaptive change of the examples of the disclosure, and these transformations, usages or adaptive changes conform to a general principle of the examples of the disclosure and include common general knowledge or conventional technical means in the technical field not disclosed by the disclosure. The specification and the examples are merely regarded as being for example, and the true scope and spirit of the examples of the disclosure are indicated by the following claims.

It is to be understood that the examples of the disclosure are not limited to the exact structure that has been described above and shown in the accompanying drawings, and that various modifications and changes may be made without departing from the scope of the disclosure. The scope of the examples of the disclosure is limited merely by the appended claims.

### INDUSTRIAL APPLICABILITY

When the at least two PUCCH channels overlap in the time domain, the PUCCH of the UCI having the high priority is preferably used for sending the multiplexed UCI. Thus, ensuring that multiplexing processing does not increase a transmission delay of the UCI having the high priority.

1. A method for sending uplink control information, performed by a user device, the method comprising:
when physical uplink control channels (PUCCHs) of at least two pieces of uplink control information (UCIs) overlap in a time domain and the at least two UCIs comprise at least one UCI corresponding to a PUCCH format0 (PF0) format and having a high priority, sending multiplexed UCI over a PUCCH of the PF0 format corresponding to any UCI in the at least one UCI, and
wherein the multiplexed UCI comprises a cyclic shift state corresponding to a combination of the at least two UCIs.

2. The method for sending the uplink control information according to claim 1, wherein
an information quantity of the combination of the at least two UCIs is less than or equal to 3 bits.

3. The method for sending the uplink control information according to claim 1, wherein
the at least two UCIs comprise at least one UCI having a low priority.

4. The method for sending the uplink control information according to claim 3, wherein
the at least one UCI having the low priority comprises at least one of:
UCI corresponding to the PF0 format and having the low priority, or
UCI corresponding to a PUCCH format1 (PF1) format and having the low priority.

5. The method for sending the uplink control information according to claim 1, wherein
the at least two UCIs comprise at least one of: a hybrid automatic repeat request ACK (HARQ-ACK) corresponding to the PF0 format and having a high priority, or a scheduling request (SR) corresponding to the PF0 format and having a high priority; and
sending the multiplexed UCI over the PUCCH of the PF0 format corresponding to any UCI in the at least one UCI comprises:
sending the multiplexed UCI over a PUCCH of a PF0 format corresponding to the HARQ-ACK; or
sending the multiplexed UCI over a PUCCH of a PF0 format corresponding to the SR.

6. (canceled)

7. The method for sending the uplink control information according to claim 1, wherein
the at least two UCIs comprise: a hybrid automatic repeat request ACK (HARQ-ACK) corresponding to the PF0 format and having a low priority, or an HARQ-ACK corresponding to a PUCCH format1 (PF1) format and having a low priority.

8. The method for sending the uplink control information according to claim 1, wherein
the at least two UCIs comprise: a scheduling request (SR) corresponding to the PF0 format and having a low priority, or an SR corresponding to a PUCCH format1 (PF1) format and having a low priority.

9. The method for sending the uplink control information according to claim 1, wherein
the at least two UCIs comprise one of:
a hybrid automatic repeat request ACK (HARQ-ACK) corresponding to the PF0 format and having a low priority, or
an HARQ-ACK corresponding to a PUCCH format1 (PF1) format and having a low priority; and
the at least two UCIs comprise one of:
a scheduling request (SR) corresponding to the PF0 format and having a low priority, or
an SR corresponding to the PF1 format and having a low priority.

10. A method for sending uplink control information, performed by a user device, the method comprising:
when physical uplink control channels (PUCCHs) of at least three pieces of uplink control information (UCIs) overlap in a time domain, and the at least three UCIs at least comprise: hybrid automatic repeat request ACK (HARQ-ACK) corresponding to a PUCCH format1 (PF1) format and having a high priority, a scheduling request (SR) corresponding to the PF1 format and having a high priority, and UCI corresponding to a PUCCH format0 (PF0) format or the PF1 format and having a low priority, determining that a value of the SR is a positive value or a negative value,
when determining that the value of the SR is the positive value, sending multiplexed UCI over a PUCCH of the SR corresponding to the PF1 format and having the high priority,
wherein the multiplexed UCI is a combination of the HARQ-ACK and the UCI corresponding to the PF0 format or the PF1 format and having the low priority; and
when determining that the value of the SR is the negative value, sending the multiplexed UCI over a PUCCH of the HARQ-ACK,
wherein the multiplexed UCI is a combination of the HARQ-ACK and an HARQ-ACK corresponding to the PF0 format or the PF1 format and having a low priority.

11. The method for sending the uplink control information according to claim 10, wherein
the UCI corresponding to the PF0 format or the PF1 format and having the low priority comprises one of:
an HARQ-ACK corresponding to the PF0 format and having a low priority,
an HARQ-ACK corresponding to the PF1 format and having a low priority,
an SR corresponding to the PF0 format and having a low priority, or
an SR corresponding to the PF1 format and having a low priority.

12-16. (canceled)

17. A user device, comprising:
a processor; and
a memory, used for storing instructions executable by the processor, wherein
the processor is configured to:
when physical uplink control channels (PUCCHs) of at least two pieces of uplink control information (UCIs) overlap in a time domain and the at least two UCIs comprise at least one UCI corresponding to a PUCCH format0 (PF0) format and having a high priority, send multiplexed UCI over a PUCCH of the PF0 format corresponding to any UCI in the at least one UC I, and
wherein the multiplexed UCI comprises a cyclic shift state corresponding to a combination of the at least two UCIs.

18. A non-transitory computer-readable storage medium, storing executable instructions, wherein when the executable instructions are executed by a processor, the processor is caused to execute the method according to claim 1.

19. The user device according to claim 17, wherein
an information quantity of the combination of the at least two UCIs is less than or equal to 3 bits.

20. The user device according to claim 17, wherein the at least two UCIs comprise at least one UCI having a low priority.

21. The user device according to claim 20, wherein the at least one UCI having the low priority comprises at least one of:
UCI corresponding to a PF0 format and having the low priority, or
UCI corresponding to a PUCCH format1 (PF1) format and having the low priority.

22. The user device according to claim 17, wherein
the at least two UCIs comprise at least one of: a hybrid automatic repeat request ACK (HARQ-ACK) corresponding to the PF0 format and having a high priority, or a scheduling request (SR) corresponding to the PF0 format and having a high priority; and
the processor is configured to:
send the multiplexed UCI over a PUCCH of a PF0 format corresponding to the HARQ-ACK; or
send the multiplexed UCI over a PUCCH of a PF0 format corresponding to the SR.

23. The user device according to claim 17, wherein
the at least two UCIs comprise: a hybrid automatic repeat request ACK (HARQ-ACK) corresponding to the PF0 format and having a low priority, or an HARQ-ACK corresponding to a PF1 format and having a low priority.

24. The user device according to claim 17, wherein
the at least two UCIs comprise: a scheduling request (SR) corresponding to the PF0 format and having a low priority, or an SR corresponding to a PUCCH format1 (PF1) format and having a low priority.

25. A user device, comprising:
a processor; and
a memory, used for storing instructions executable by the processor, wherein
the processor is configured to execute the instructions so as to implement steps of the method for sending the uplink control information according to claim 10.

26. A non-transitory computer-readable storage medium, storing executable instructions, wherein when the executable instructions are executed by a processor, the processor is caused to execute the method according to claim 10.
